(19) United States
(12) Patent Application Publication
(10) Pub. No.: US 2008/0229663 A1
(43) Pub. Date: Sep. 25, 2008

(54) Apparatus and method for operating an auxiliary door

(76) Inventors: Richard Armstrong, Swansboro, NC (US); Richard Armstrong, Blacksburg, VA (US)

Correspondence Address: THE LAW OFFICE OF JOHN T. WHELAN, L.L.C., 135 WEST DARES BEACH ROAD, SUITE 204, PRINCE FREDERICK, MD, 20678, US

(21) Appl. No.: 11/726,422

(22) Filed: Mar. 22, 2007

(51) Int. Cl. E05F 1/00; E05F 15/00

(52) U.S. Cl. 49/28; 49/324

(57) ABSTRACT

An improved apparatus and method for operating an auxiliary door is provided. Preferably, a remote signal, such as a radio signal, is used to initiate the opening of the door by a battery powered cable-retracting device or the like. The device is generally mounted on the wall adjacent to the door, but could also be mounted on the door. A cantilever extends out from the wall and door at the door hinge. A cable operated by a motor and pulley in the device is attached to the door such that when the motor is energized the door is opened to the cantilever overcoming the closing force for the door. This force is normally provided by a spring, hydraulic, pneumatic, or other known door closing device. Controls are provided to stop the opening motion if an obstacle blocks the door.

### FIELD OF THE INVENTION

This invention relates generally to an improved apparatus and method for opening a door, such as an auxiliary door, more specifically to a device operable remotely by an operator to enable the automatic opening of the door.

### BACKGROUND OF THE INVENTION

In order to save energy and better control the temperature in many homes, a second door is installed in the major entrances. These doors generally have a removable panel providing a screened entry. The door typically is installed on the outside of the house and opens by pulling on a handle and moving back from or to the side of the portal as it opens. The door opening is opposed by a spring, hydraulic, or pneumatic device to reclose the door; thus the person entering must also hold the door open against the opposing force as they pass through the doorway. Handicapped persons, as well as persons in a wheelchair or on crutches, often do not have a hand free to open the door and have great difficulty in moving to allow the door to open. A device to open such a door would be a valuable asset. It would need to be easy to install and not hinder normal door operation when not in use.

### SUMMARY OF THE INVENTION

According to a preferred embodiment of the present invention there is provided an improved apparatus and method for operating an auxiliary door. Preferably, a remote signal, such as a radio signal, is used to initiate the opening of the door by an electric motor powered cable-retracting device or the like. The device is generally mounted on the wall adjacent to the hinged side of the door, but could also be mounted on the door. One end of the device is cantilevered out from the wall and door at the door hinge. A cable operated by a motor and pulley in the device is attached to the door such that when the motor is energized the door is pulled opened to the cantilever overcoming the closing force for the door. This force is normally provided by a spring, hydraulic, pneumatic, or other known door closing device. Controls are provided to stop the opening motion if an obstacle blocks the door. The effort to open the door will restart in a few seconds, thus allowing time for the obstacle, generally the person entering, to be cleared. When the door is fully open, a displacement or proximity switch stops further opening. The door remains open since the force of the door closing device is insufficient to backdrive the gear motor. Additional manual force could be applied to backdrive the motor and close the door in an emergency situation assuming for some reason that motorized closure was not possible. A second signal, reversing the motor, allows the cable to extend at a uniform rate opposing the force of the closing device. If an obstacle blocks the closing of the door, the extension of the cable will cease until the obstacle is removed. If the opening device becomes inoperable during opening or closing, the cable is easily detached at the door be removing a pin through loop in the end of the cable.

An additional advantage of the device is that the door is free to open in a normal manner only causing the cable to go slack.

In order for this device to work the latch on the door must be deactivated or an unlatching mechanism must be provided. Such a device may be easily incorporated into the electronic controls of the opener, thus making the device easily retrofitted to most exterior, outside-opening doors that are fitted with a closing device.

Additional features and advantages of the present invention are described in and will be apparent from, the following Detailed Description of the Invention and the figures.

### BRIEF DESCRIPTION OF THE DRAWINGS

FIG. 1 is a diagram of a side view of the opener of the present invention in an operating position, perpendicular to the door and parallel to the top of the door.

FIG. 2 is a diagram of an end view of the door opener of the present invention in an operating position.

FIG. 3 is a diagram of a cable drive system of the door opener of the present invention.

FIG. 4 is a diagram of the off switch controlling the fully open position of the door.

### DETAILED DESCRIPTION

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms first and second are used herein to describe various elements, these elements should not be limited by these terms. These terms are only used to distinguish one element from another element. As used herein, the term “and/or” includes any and all combinations of one or more of the associated listed items. The symbol “/” is also used as a shorthand notation for “and/or”.

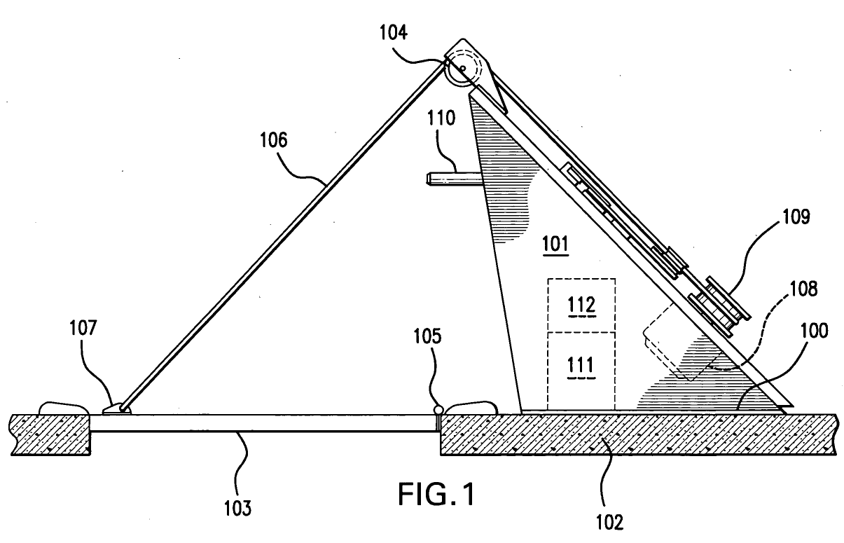

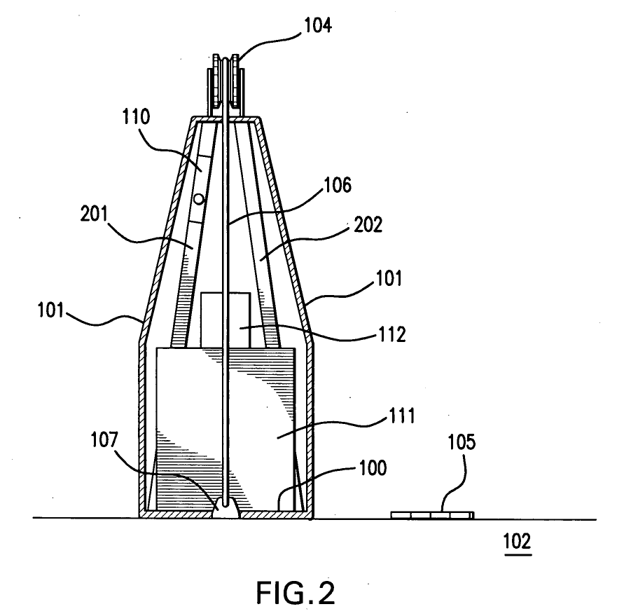

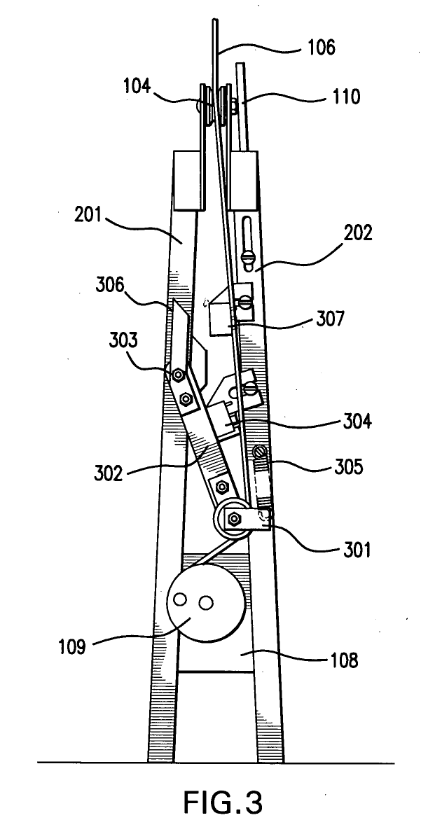

As illustrated in FIGS. 1 through 4, a method and apparatus for opening an auxiliary door by remote control are provided. Specifically, the method and apparatus of the present invention may be used in conjunction with a traditional storm door closer (such as commercially available pneumatic or hydraulic closers). As shown in FIGS. 1 and 2, a base 100 is provided to support the operational elements shown in FIG. 3. The base 100 of the triangular shaped structural housing 101 is rigidly mounted to the wall 102 adjacent to and perpendicular to door 103 such that the cable pulley 104 is outside the door hinge 105 line. A cable 106 is pivotally connected to fixture 107 at a distance from the hinge 105 equal to the perpendicular distance of the cable pulley 104 to the wall. Alternatively, instead of a cable, alternative means may be used between the housing 101 and door 103 including, for example, a chain or the like as will be appreciated by those skilled in the art. Door 103 is constrained in the closed position by, for example, a spring or standard door closer (not shown) such that when the door 103 is opened there is sufficient force on the door 103 to return it to the closed position. When a pulley motor 108 is activated by a remote signal, a motor pulley 109 winds cable 106 pulling the door 103 open. As the door 103 approaches 90 degrees open it contacts proximity switch 110 stopping the pulley motor 108. The unenergized pulley motor 108 has sufficient friction to hold door 103 against the closing force.

A second radio signal starts the pulley motor 108 in reverse and negates stop switch 110 letting cable 106 unwind allowing the door 103 to close by the force of the closer or spring (not shown). The rate of closure is controlled by the speed of rotation of the motor pulley 109. The operating battery 111 or other power source and the electronic controls package 112 are placed within the form of the structural housing 101.

FIG. 2 shows the device of the present invention from a view perpendicular to that of FIG. 1. Shown are additional structural members 201 and 202 and the position of the battery 111 and electronic control s package 112.

The motion of the door 103 is further controlled during opening and closing to protect the entrant by the mechanism illustrated in FIG. 3. As shown therein, cable 106 after passing over cable pulley 104 runs through catenary pulley 301 and then is securely attached to motor pulley 109. Catenary pulley arm 302 is pivotally attached to structural member 201 at location 303. Catenary pulley arm 302 is constrained against an undertension detecting microswitch 304 by spring 305 when the door 103 is stopped upon closing. The microswitch 304 interrupts current to the pulley motor 108 when the door is closed but also if an obstruction stops the door 103 before it is closed. When the obstruction is removed, tension provided by the closing force overcomes the force of spring 305 starting the motor 108 allowing the door 103 to close farther until it is fully closed.

When an opening signal is received the closing switch is negated and the pulley motor 108 reverses its direction to wind up cable 106 on motor pulley 109. The force of winding against the closing force tends to straighten the catenary in cable 106 putting tension in spring 305. If the tension force becomes greater than that typically required to open the door due, for example, to the present of an obstruction, possibly the entrant, the angle in the catenary will straighten. Contact 306 rigidly attached to arm 302 will then close overtension detecting microswitch 307, which stops pulley motor 108. A delay in the application of the operating force, say of 4 seconds, allows the obstruction to be removed. The pulley motor 108 again energized when attempting to open door. This sequence will continue until the door is completely (90 degrees) open and the motor 108 is stopped by the displacement or proximity switch 110.

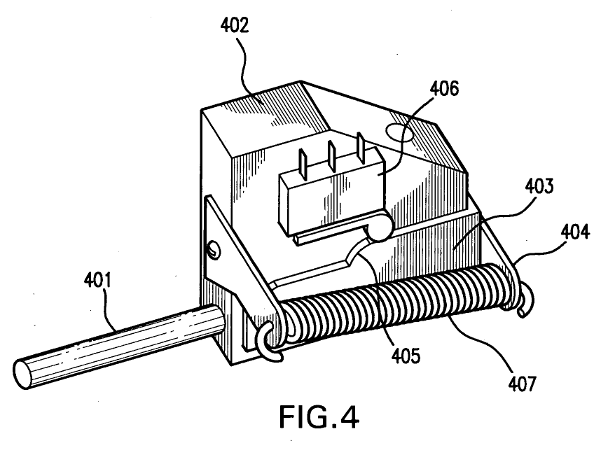

FIG. 4 shows a preferred construction of switch 110. Rod 401 freely moves in block 402. Slide 403 and spring bracket 404 are securely attached to rod 401. When rod 401 is pushed by the door 103 reaching the open position, the ramp 405 on slide 403 allows microswitch 406 to interrupt the power to pulley motor 108 stopping the door. When the door is closed, spring 407 restores rod 401 to its original position in preparation of the next door opening.

The electrical circuitry for the remote operation, power control of the pulley motor and other operating switches are methods well established and require no special techniques not used in general practice.

It will be appreciated that the apparatus and operations described above are illustrative examples, and that other architectures and operations fall within the scope of the present invention. More generally, in the drawings and specification, there have been disclosed exemplary embodiments of the invention. Although specific terms are employed, they are used in a generic and descriptive sense only and not for purposes of limitation, the scope of the invention being defined by the following claims.

What is claimed is:

1. An apparatus for operating a door, comprising:
a housing adapted to be fixedly secured to a wall adjacent said door;
a cable, secured on a first end thereof to said door and on a second end thereof to said housing;
at least one pulley, mounted on said housing and in operable contact with said cable;
a motor operable to retract said cable to open said door and to expend send cable to close said door, said motor being capable of being remotely controlled;
a proximity switch electrically coupled to said motor to determine when said door is fully open and to communicate same to said motor; and
a spring loaded catenary pulley arm positioned proximate to at least one microswitch, said catenary pulley arm and said at least one microswitch being operable to interrupt the opening and closing of said door when an obstruction is present and being further operable to resume the opening and closing of said door when said obstruction is removed.

2. An apparatus according to claim 1, further comprising a proximity switch operable to stop the retraction effected by said motor when said door reaches an open position.

3. An apparatus according to claim 1, wherein one of same at least one microswitches comprises an overtension detecting switch operable to stop said motor when the opening of the door is impeded by an obstruction.

4. An apparatus according to claim 1, wherein one of same at least one microswitches comprises an undertension detecting switch operable to stop said motor when the closing of the door is impeded by an obstruction.

5. An apparatus according to claim 3, wherein said overtension detecting switch is adjustable for varying obstructing forces.

6. An apparatus according to claim 1, wherein the spring force on the catenary arm is adjustable to accommodate doors with varying closing and opening forces.
